(19) United States
(12) Patent Application Publication
(10) Pub. No.: US 2026/0102829 A1
(43) Pub. Date: Apr. 16, 2026

(54) Dual-Bladed Multi-Tool Device

(71) Applicant: Henry Morris, Friendswood, TX (US)

(72) Inventor: Henry Morris, Friendswood, TX (US)

(21) Appl. No.: 18/916,022

(22) Filed: Oct. 15, 2024

(51) Int. Cl. B23D 1/00; B23D 51/10

(52) U.S. Cl. CPC B23D 1/006; B23D 51/10

(57) ABSTRACT

A dual-bladed multi-tool device for oscillating a pair of blades in opposite directions to facilitate a user in cutting materials includes a housing coupled to a pair of blades. The pair of blades includes an upper blade with an upper blade coupling end positioned within the housing. An upper blade cutting edge is distal to the housing. The upper blade cutting edge is sharpened to cut an object. A lower blade is positioned beneath the upper blade. The lower blade has a lower blade coupling end positioned within the housing. A lower blade cutting edge is aligned with the upper blade cutting edge. The lower blade cutting edge is sharpened to cut the object. A drive assembly coupled to the housing moves the upper blade cutting edge and the lower blade cutting edge in opposing directions to facilitate the user in cutting the object with the pair of blades.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to power tools and more particularly pertains to a new power tool for oscillating a pair of blades in opposite directions to facilitate a user in cutting materials.

### (2) Description of Related Art Including Information Disclosed Under 37 CFR 1.97 and 1.98.

The prior art relates to power tools. Power tools are commonly used in many situations, including building, designing, and renovating. For example, the prior art discloses multi-tools, which are portable devices with blades which can be used for sawing, sanding, cutting, polishing, scraping, grinding, and more. For example, a multi-tool may include a circular or rectangular blade which can be oscillated to facilitate the sawing, sanding, or cutting. However, the single blade of the multi-tool can be difficult to control, and cutting through larger pieces of material can be extremely time consuming. Thus, there is a need for a power tool with two blades that oscillate in opposing directions to increase the cutting speed of the tool and to make the tool easier for a user to control.

### (h) BRIEF SUMMARY OF THE INVENTION

An embodiment of the disclosure meets the needs presented above by generally comprising a housing. A pair of blades is coupled to a drive assembly located within the housing. The pair of blades extends outwardly from the housing. The pair of blades includes an upper blade with an upper blade coupling end that is positioned within the housing. An upper blade cutting edge is distal to the housing. The upper blade cutting edge is sharpened wherein the upper blade cutting edge is configured to cut an object. A lower blade is positioned beneath the upper blade. The lower blade has a lower blade coupling end that is positioned within the housing. A lower blade cutting edge is aligned with the upper blade cutting edge of the upper blade. The lower blade cutting edge is sharpened wherein the lower blade cutting edge is configured to cut the object. The drive assembly moves the upper blade cutting edge of the upper blade and the lower blade cutting edge of the lower blade in opposing directions wherein the drive assembly is configured to facilitate a user in cutting the object with the pair of blades.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front isometric view of a dual-bladed multi-tool device according to an embodiment of the disclosure.

FIG. 2 is a side view of an embodiment of the disclosure.

FIG. 3 is a side view of an embodiment of the disclosure.

FIG. 4 is a side view of an embodiment of the disclosure.

FIG. 5 is a detail top view of an embodiment of the disclosure.

FIG. 6 is an isometric of an embodiment of the disclosure.

FIG. 7 is a detail top view of an embodiment of the disclosure.

### (j) DETAILED DESCRIPTION OF THE INVENTION

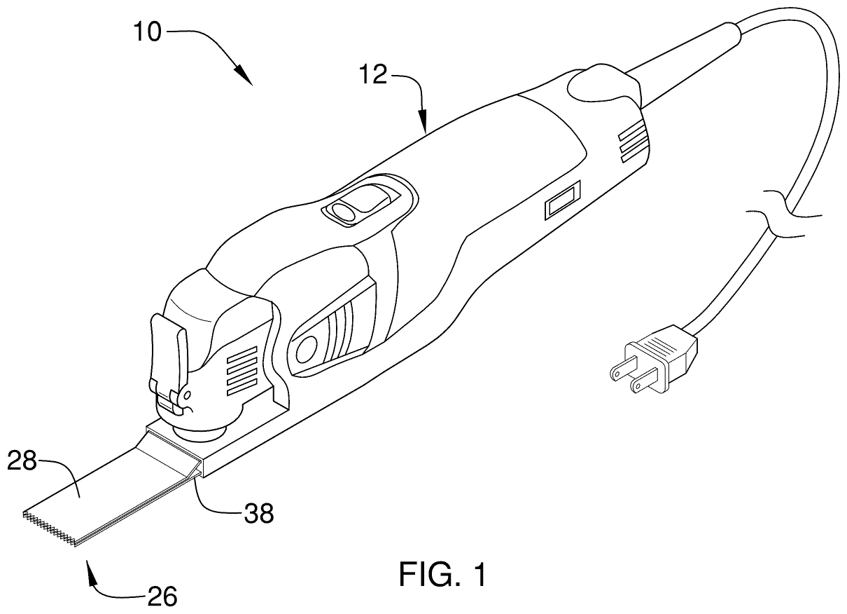

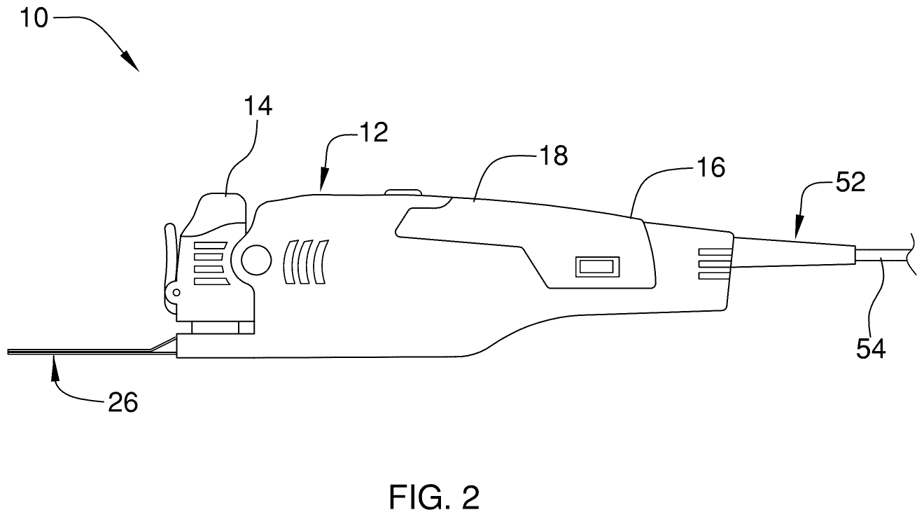

With reference now to the drawings, and in particular to FIGS. 1 through 7 thereof, a new power tool embodying the principles and concepts of an embodiment of the disclosure and generally designated by the reference numeral 10 will be described.

As best illustrated in FIGS. 1 through 7, the dual-bladed multi-tool device 10 generally comprises a housing 12. The housing 12 generally includes a head end 14, a handle end 16, and an elongated body 18 that is coupled to and extends between the head end 14 and the handle end 16 to define an interior space 20. The elongated body 18 may narrow between the head end 14 and the handle end 16 wherein the elongated body 18 is configured to be held by a user proximate to the handle end 16. The housing 12 also generally includes a top side 22 and a bottom side 24.

A pair of blades 26 is coupled to a drive assembly 48 located within the housing 12. In some embodiments, the pair of blades 26 may be removably coupled to the housing 12. For example, as explained further below, the drive assembly 48 may include an upper drive plate 68 and a lower drive plate 72, and the pair of blades 26 may be removably coupled to the upper drive plate 68 and the lower drive plate 72. The pair of blades 26 is generally positioned at the head end 14. The pair of blades 26 may extend outwardly from the head end 14.

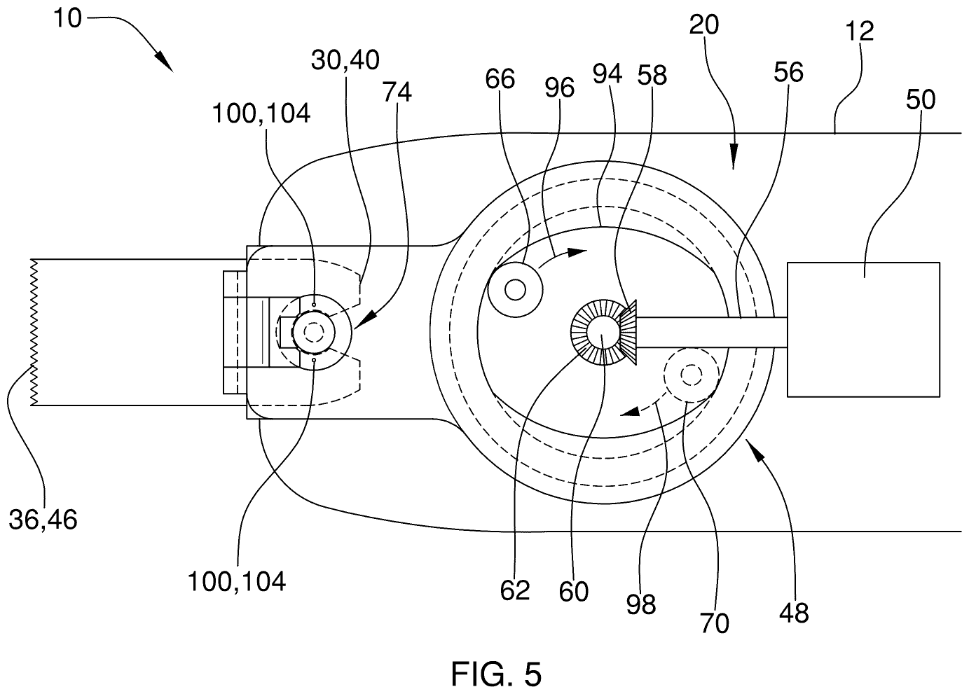

An upper blade 28 of the pair of blades 26 may include an upper blade coupling end 30. The upper blade coupling end 30 is positioned within the head end 14 of the housing 12. The upper blade coupling end 30 may be removably positionable within the housing 12. For example, the upper blade coupling end 30 may be removably attached to the upper drive plate 68 located within the housing 12. The upper blade coupling end 30 may have an upper blade coupling end primary edge 32 and an upper blade coupling end secondary edge 34. The upper blade coupling end 30 may be concavely arcuate between the upper blade coupling end primary edge 32 and the upper blade coupling end secondary edge 34, as shown in FIG. 5.

An upper blade cutting edge 36 is generally spaced from the housing 12. For example, the upper blade cutting edge 36 may be distally positioned on the upper blade 28 relative to the upper blade coupling end 30, wherein the upper blade cutting edge 36 is distally positioned relative to the housing 12. The upper blade cutting edge 36 is sharpened wherein the upper blade cutting edge 36 is configured to cut an object such as a piece of wood or a piece of sheetrock. For example, the upper blade cutting edge 36 may be serrated.

A lower blade 38 of the pair of blades 26 may be positioned beneath the upper blade 28. The lower blade 38 may include a lower blade coupling end 40 that is generally positioned within the head end 14 of the housing 12. The lower blade coupling end 40 may be removably positionable within the housing 12. For example, the lower blade coupling end 40 may be removably attached to the lower drive plate 72 located within the housing 12. The lower blade coupling end 40 may have a lower blade coupling end primary edge 42 and a lower blade coupling end secondary edge 44. The lower blade coupling end 40 may be concavely arcuate between the lower blade coupling end primary edge 42 and the lower blade coupling end secondary edge 44.

A lower blade cutting edge 46 of the lower blade 38 is generally aligned with the upper blade cutting edge 36 of the upper blade 28. The lower blade cutting edge 46 is sharpened wherein the lower blade cutting edge 46 is configured to cut the object. For example, the lower blade cutting edge 46 may be serrated.

The drive assembly 48 is coupled to the housing 12. The drive assembly 48 is generally located within the housing 12. As explained above, the drive assembly 48 is coupled to the pair of blades 26. The drive assembly 48 moves the upper blade cutting edge 36 of the upper blade 28 and the lower blade cutting edge 46 of the lower blade 38 in opposing directions wherein the drive assembly 48 is configured to facilitate the user in cutting the object with the pair of blades 26. Generally, the drive assembly 48 moves each blade of the pair of blades 26 from side to side. For example, the upper blade cutting edge 36 may move from right to left while the lower blade cutting edge 46 moves from left to right. In another example, the upper blade cutting edge 36 may move from left to right while the lower blade cutting edge 46 moves from right to left. Each blade of the pair of blades 26 cuts the object wherein the pair of blades 26 is configured to increase a rate at which the user is able to cut the object compared to use of a single blade.

The drive assembly 48 may include a motor 50 that is positioned in the interior space 20. A power input 52 may be coupled to the housing 12. The power input 52 is electrically coupled to the motor 50. The power input 52 may be configured to be electrically couplable to an extrinsic power source wherein the power input 52 is configured to transfer power from the extrinsic power source to the motor 50. For example, the power input 52 may include a power cord 54 that extends from the handle end 16 of the housing 12. In another example, the power input 52 may comprise a detachable battery that powers the motor 50.

A drive shaft 56 may be coupled to the motor 50 wherein the drive shaft 56 is rotated by the motor 50. The drive shaft 56 generally extends from the motor 50, for example toward the head end 14 of the housing 12. A drive shaft gear 58 may be coupled to the drive shaft 56 wherein the drive shaft gear 58 is distally positioned relative to the motor 50.

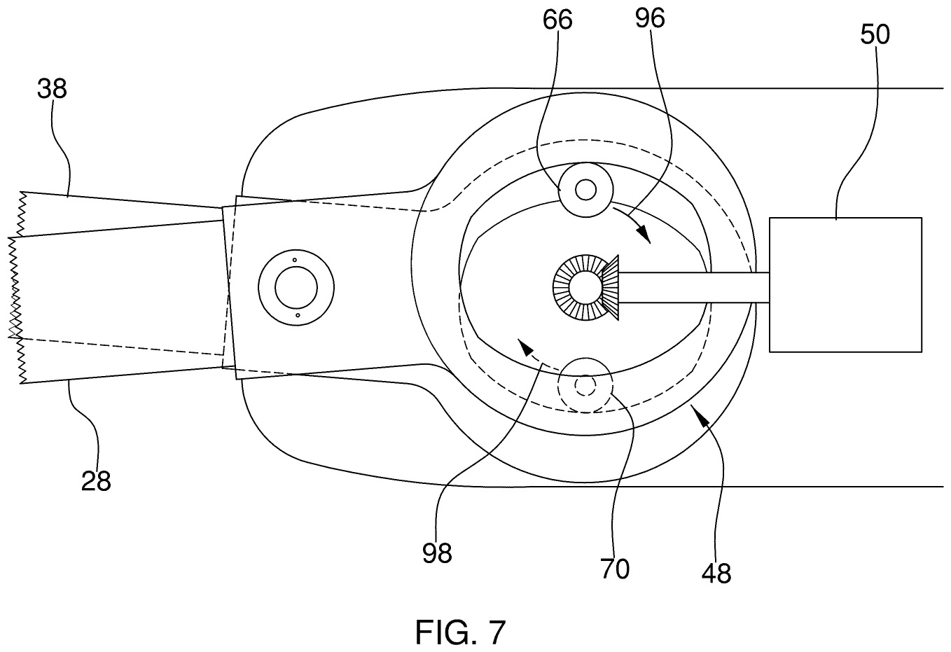

A spindle 60 may be positioned in the interior space 20. The spindle 60 engages the drive shaft 56 wherein rotation of the drive shaft 56 rotates the spindle 60. The spindle 60 may be perpendicular to the drive shaft 56. For example, as shown in FIG. 7, the drive shaft 56 may be parallel to the pair of blades 26 and the spindle 60 may be perpendicular to the pair of blades 26 and the drive shaft 56. A spindle gear 62 may be coupled to the spindle 60. The spindle gear 62 physically contacts the drive shaft gear 58 to engage the spindle 60 with the drive shaft 56.

A drive wheel 64 may be coupled to the spindle 60. The drive wheel 64 is generally spaced from the drive shaft 56. For example, the drive wheel 64 may be distally positioned on the spindle 60 relative to the spindle gear 62. Rotation of the spindle 60 rotates the drive wheel 64. The drive wheel 64 may be circular. The drive wheel 64 may be planar.

An upper drive bearing 66 may be coupled to the drive wheel 64. The upper drive bearing 66 extends upwardly from the drive wheel 64. The upper drive bearing 66 may be rotated or pivoted in a first direction around a drive radius 94 when the drive wheel 64 is rotated. For example, when the drive wheel 64 is rotated in a clockwise direction, the upper drive bearing 66 may be rotated or pivoted in the clockwise direction around the drive radius 94. Alternatively, when the drive wheel 64 is rotated in a counterclockwise direction, the upper drive bearing 66 may be pivoted or rotated in the counterclockwise direction around the drive radius 94. The drive radius 94 may be oblong, or elliptical, wherein the drive radius 94 is configured to facilitate the oscillation of the pair of blades 26.

An upper drive plate 68 may be coupled to the upper drive bearing 66. The rotation of the upper drive bearing 66 in the first direction oscillates the upper drive plate 68 in a primary direction. The upper blade 28 is generally coupled to the upper drive plate 68 wherein oscillation of the upper drive plate 68 oscillates the upper blade 28 in the primary direction. For example, the upper drive plate 68 and the upper blade 28 may oscillate from right to left, before moving back from left to right. In other embodiments, the upper drive plate 68 and the upper blade 28 may oscillate from left to right, before moving back from right to left.

A lower drive bearing 70 may be coupled to the drive wheel 64. The lower drive bearing 70 extends downwardly from the drive wheel 64. The lower drive bearing 70 may be rotated or pivoted in the first direction around the drive radius 94 when the drive wheel 64 is rotated. Generally, the lower drive bearing 70 is rotated or pivoted around the drive radius 94 in the same direction as the upper drive bearing 66. For example, when the drive wheel 64 is rotated in the clockwise direction, the lower drive bearing 70 may be rotated or pivoted in the clockwise direction around the drive radius 94. Alternatively, when the drive wheel 64 is rotated in a counterclockwise direction, the lower drive bearing 70 may be pivoted or rotated in the counterclockwise direction around the drive radius 94.

A lower drive plate 72 may be coupled to the lower drive bearing 70. Rotation of the lower drive bearing 70 in the first direction oscillates the lower drive plate 72 in a secondary direction. The lower blade 38 is coupled to the lower drive plate 72 wherein oscillation of the lower drive plate 72 oscillates the lower blade 38. Generally, the lower drive plate 72 and the lower blade 38 oscillate in the opposite direction from the upper drive plate 68 and the upper blade 28. This may be referred to as harmonic oscillation, wherein a first one of the pair of blades 26 pivots from right to left as the second one of the pair of blades 26 pivots from left to right.

The harmonic oscillation is achieved because the upper drive bearing 66 and the lower drive bearing 70 are located equidistantly from the center of the drive wheel 64, are both positioned along the diameter of the drive wheel 64, and they positioned on opposite sides of the drive wheel 64, namely with the upper drive bearing 66 being positioned on top of the drive wheel 64 and the lower drive bearing 70 being positioned beneath the drive wheel 64. Rotation of the drive wheel 64 causes the upper drive bearing 66 and the lower drive bearing 70 to oscillate the upper drive plate 68 and the lower drive plate 72 in opposing directions. In other words, the upper drive bearing 66 and the lower drive bearing 70 may be pivoted together around the drive radius 94, such that the upper blade 28 and the lower blade 38 are oscillated in opposing directions. In such circumstances, the drive radius 94 may include an upper drive radius 96, around which the upper drive bearing 66 is oscillated, and a lower drive radius 98, around which the lower drive bearing 70 is oscillated. As shown in FIG. 5, both the upper drive radius 96 and the lower drive radius 98 may be clockwise when the drive wheel 64 is rotated in the clockwise direction. Alternatively, both the upper drive radius 96 and the lower drive radius 98 may be counterclockwise when the drive wheel 64 is rotated in the counterclockwise direction. The relative positioning of the upper drive bearing 66 and the lower drive bearing 70 on the drive wheel 64 is configured to facilitate the harmonic oscillation of the pair of blades 26.

The equal and opposite interaction of the upper drive bearing 66 and the lower drive bearing 70 with the upper drive radius 96 and the lower drive radius 98, respectively, causes the harmonic oscillation of the upper drive plate 68 and the lower drive plate 72, and the pair of blades 26 which are attached to them. For example, rotation of the upper drive bearing 66 around the upper drive radius 96 may result in oscillation of the upper blade 28 in a primary direction, such that the upper blade cutting edge 36 moves from right to left. Rotation of the lower drive bearing 70 around the lower drive radius 98 may result in oscillation of the lower blade 38 in a secondary direction, such that the lower blade cutting edge 46 moves from left to right beneath the upper blade cutting edge 36.

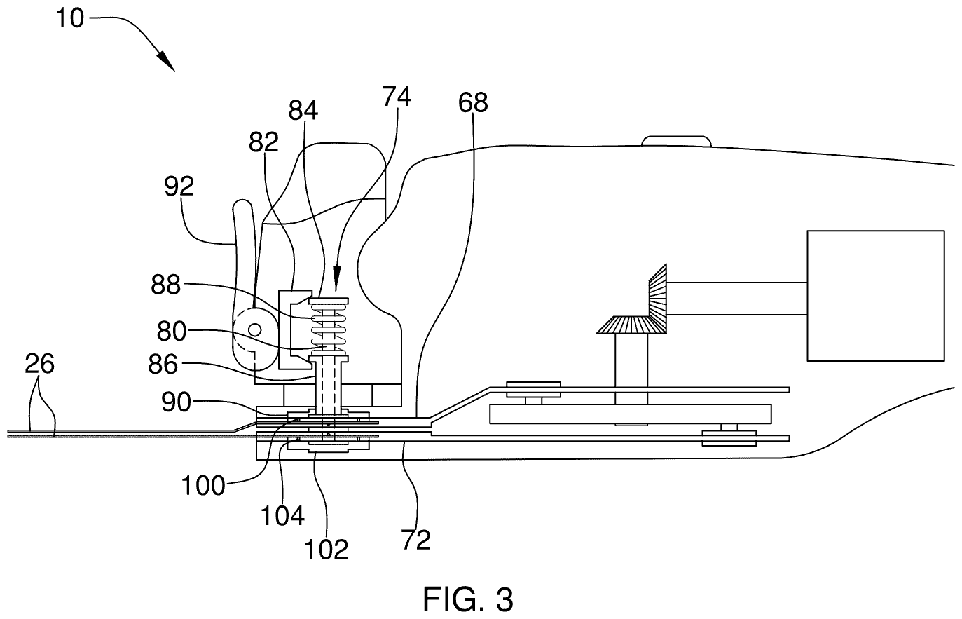

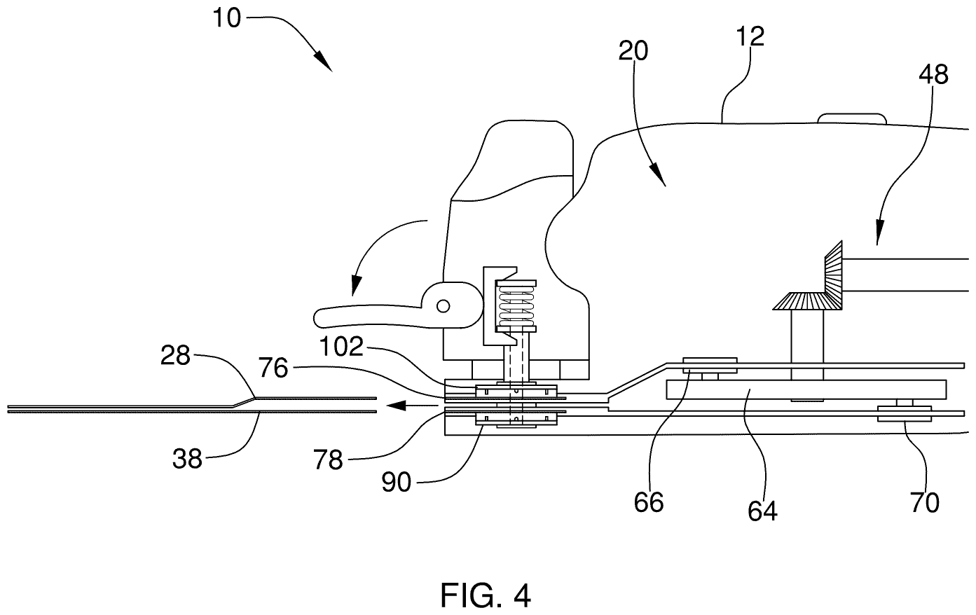

A blade retainer assembly 74 may releasably couple the upper blade 28 to the upper drive plate 68, and the lower blade 38 to the lower drive plate 72, as shown in FIGS. 3 and 4. For example, an upper blade slot 76 extending into the upper drive plate 68 may hold the upper blade 28 of the pair of blades 26 and a lower blade slot 78 extending into the lower drive plate 72 may hold the lower blade 38 of the pair of blades 26.

The upper blade slot 76 may extend through the head end 14 of the housing 12 into the upper drive plate 68. The upper blade slot 76 generally has dimensions that are complementary to dimensions of the upper blade 28 wherein the upper blade 28 is positionable within the upper blade slot 76.

The lower blade slot 78 may extend through the head end 14 of the housing 12 into the lower drive plate 72. The lower blade slot 78 generally has dimensions that are complementary to dimensions of the lower blade 38 wherein the lower blade 38 is positionable within the lower blade slot 78.

A pole 80 may be positioned within the head end 14 of the housing 12. The pole 80 may extend through the upper drive plate 68 and the lower drive plate 72. The pole 80 may be perpendicular to the upper drive plate 68 and the lower drive plate 72 wherein the pole 80 extends upwardly from the bottom side 24 of the housing 12.

A blade change lever 92 may be pivotably coupled to the head end 14 of the housing 12. The blade change lever 92 may be pivotable away from the housing 12 to release the pair of blades 26. The blade change lever 92 may be pivotable toward the housing 12 to secure the pair of blades 26.

A blade change detent 82 may be coupled to the blade change lever 92. The blade change detent 82 may be movably positioned within the head end 14 of the housing 12 wherein the blade change detent 82 moves inwardly toward the pole 80 when the blade change lever 92 is pivoted away from the housing 12 and wherein the blade change detent 82 moves outwardly from the pole 80 when the blade change lever 92 is pivoted toward the housing 12. The blade change detent 82 may be spaced from the pole 80 when the blade change lever 92 is pivoted away from the housing 12.

A lower blade retainer pivot 84 may be coupled to the pole 80. The lower blade retainer pivot 84 may be positioned above the upper drive plate 68. The blade change detent 82 may contact the lower blade retainer pivot 84 when the blade change detent 82 is moved inwardly toward the pole 80.

An upper blade retainer pivot 86 may be movably coupled to the pole 80. The upper blade retainer pivot 86 is generally spaced from the lower blade retainer pivot 84 and may be positioned above the upper drive plate 68. The blade change detent 82 may contact the upper blade retainer pivot 86 when the blade change detent 82 is moved inwardly toward the pole 80. The upper blade retainer pivot 86 may be moved upwardly along the pole 80 toward the lower blade retainer pivot 84 when the blade change detent 82 contacts the upper blade retainer pivot 86. The upper blade retainer pivot 86 may be moved downwardly along the pole 80 away from the lower blade retainer pivot 84 when the blade change detent 82 is spaced from the pole 80.

A tension spring 88 may be coupled to the pole 80. The tension spring 88 may be positioned between the lower blade retainer pivot 84 and the upper blade retainer pivot 86. The tension spring 88 may be compressed when the upper blade retainer pivot 86 moves toward the lower blade retainer pivot 84. The tension spring 88 may be released when the upper blade retainer pivot 86 moves away from the lower blade retainer pivot 84.

A lower blade retainer 90 may be coupled to the pole 80. The pole 80 may urge the lower blade retainer 90 upwardly toward the lower drive plate 72 to secure the lower blade 38 within the lower blade slot 78 when the blade change detent 82 is spaced from the pole 80. The pole 80 may urge the lower blade retainer 90 downwardly from the lower drive plate 72 to release the lower blade 38 from the lower blade slot 78 when the blade change detent 82 is moved inwardly toward the pole 80.

The lower blade retainer 90 may include a pair of lower blade pins 100. The pair of lower blade pins 100 may engage the lower blade 38 when the lower blade retainer 90 is urged upwardly toward the lower drive plate 72. The pair of lower blade pins 100 may be spaced from the lower blade 38 when the lower blade retainer 90 is urged downwardly from the lower drive plate 72.

An upper blade retainer 102 may be coupled to the upper blade retainer pivot 86. The upper blade retainer pivot 86 may urge the upper blade retainer 102 downwardly toward the upper drive plate 68 to secure the upper blade 28 within the upper blade slot 76 when the tension spring 88 is released. The upper blade retainer pivot 86 may urge the upper blade retainer 102 upwardly from the upper drive plate 68 to release the upper blade 28 form the upper blade slot 76 when the tension spring 88 is compressed.

The upper blade retainer 102 may include a pair of upper blade pins 104. The pair of upper blade pins 104 may engage the upper blade 28 when the upper blade retainer 102 is urged downwardly toward the upper drive plate 68. The pair of upper blade pins 104 may be spaced from the upper blade 28 when the upper blade retainer 102 is urged upwardly from the upper drive plate 68.

In use, the dual-bladed multi-tool device 10 can be used in the same manner as a conventional single-bladed multi-tool. The dual-bladed multi-tool device 10 can also be used to perform flush cuts, plunge cuts, and other precision cuts that are difficult or impossible to perform with other power tools. The upper blade 28 and the lower blade 38 cooperate to cut, slice, or trim the object. Because the upper blade cutting edge 36 and the lower blade cutting edge 46 oscillate in opposing directions, the pair of blades 26 is able to cut through the object at a faster rate than use of a single blade. The opposing oscillation of the pair of blades 26 may also reduce the amount of effort needed to cut through the object compared to use of a single blade. The dual-bladed multi-tool device may also be easier for the user to control than a single-bladed multi-tool, resulting in more accurate cuts and less user fatigue.

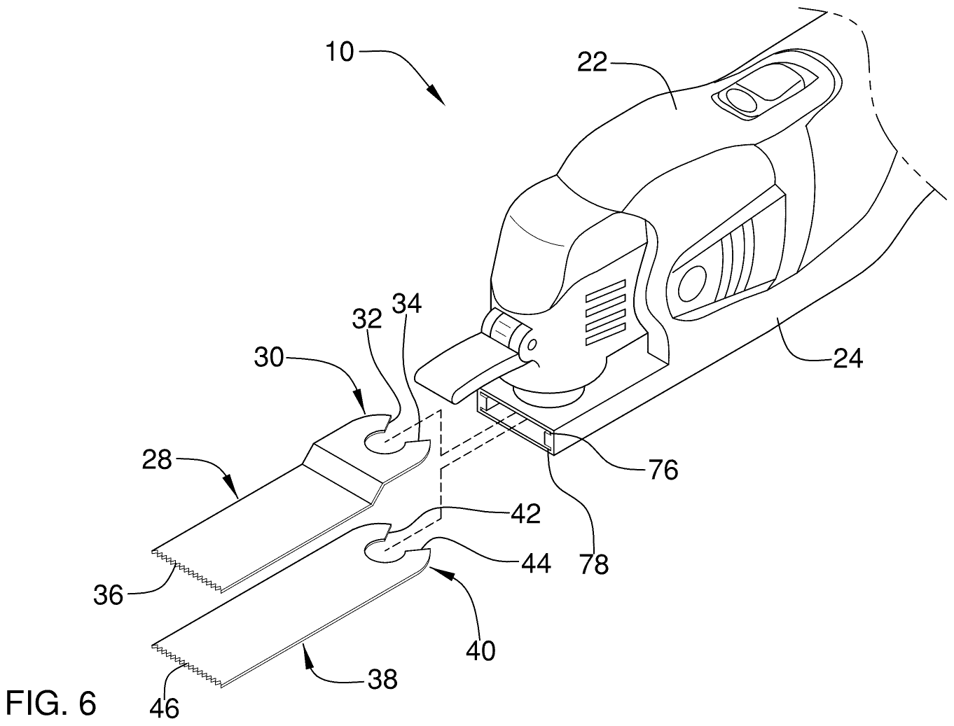

In the embodiments shown in FIGS. 1 and 6, each blade of the pair of blades 26 may be serrated. In other embodiments, the upper blade cutting edge 36 and the lower blade cutting edge 46 may be straight and non-serrated, which may be useful to obtain smoother cuts. Because the pair of blades 26 may be removably coupled to the housing 12, the pair of blades 26 may be swapped out for different applications. For example, the user may remove the pair of blades 26 shown in FIG. 5 to replace the pair of blades 26 with blades that have smooth cutting edges. Alternative shapes and designs of the cutting edges are also contemplated, for use in different applications. The lower blade cutting edge 46 is generally vertically aligned with the upper blade cutting edge 36, as shown in FIGS. 3 and 4, so that both cutting edges of the pair of blades 26 can cooperate to cut the object.

To remove the pair of blades 26 from the housing 12, the user can simply pivot the blade change lever 92 outwardly away from the housing 12. When the blade change lever 92 is pivoted outward, the blade change detent 82 is moved inwardly toward the pole, such that the blade change detent 82 contacts each of the lower blade retainer pivot 84 and the upper blade retainer pivot 86. The blade change detent 82 urges the lower blade retainer pivot 84 and the upper blade retainer pivot 86 toward each other along the pole 80, compressing the tension spring 88 between the lower blade retainer pivot 84 and the upper blade retainer pivot 86. Compression of the tension spring 88 pulls the upper blade retainer 102 away from the upper drive plate 68 and pushes the lower blade retainer 90 away from the lower drive plate 72, releasing the pair of blades 26 from the upper blade slot 76 and the lower blade slot 78.

To secure the pair of blades 26 to the drive assembly 48 within the housing 12, the user can simply pivot the blade change lever 92 inwardly toward the housing 12. When the blade change lever 92 is pivoted inward, the blade change detent 82 is spaced from the lower blade retainer pivot 84 and the upper blade retainer pivot 86, releasing the tension spring 88 and urging the upper blade retainer 102 and the lower blade retainer 90 toward one another. When the tension spring 88 is released, the upper blade retainer 102 contacts the upper drive plate 68 and the lower blade retainer 90 contacts the lower drive plate 72. The pair of upper blade pins 104 and the pair of lower blade pins 100 may contact the pair of blades 26 to secure them within the upper blade slot 76 and the lower blade slot 78.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A power tool assembly comprising:
a housing;
a pair of blades being coupled to the housing, the pair of blades extending outwardly from the housing, the pair of blades including:
an upper blade including:
an upper blade coupling end being positioned within the housing;
an upper blade cutting edge being spaced from the housing, the upper blade cutting edge being sharpened wherein the upper blade cutting edge is configured to cut an object;
a lower blade being positioned beneath the upper blade, the lower blade including:
a lower blade coupling end being positioned within the housing;
a lower blade cutting edge being aligned with the upper blade cutting edge of the upper blade, the lower blade cutting edge being sharpened wherein the lower blade cutting edge is configured to cut the object; and
a drive assembly being positioned within the housing, the pair of blades being coupled to the drive assembly, the drive assembly moving the upper blade cutting edge of the upper blade and the lower blade cutting edge of the lower blade in opposing directions wherein the drive assembly is configured to facilitate a user in cutting the object with the pair of blades.

2. The power tool assembly of claim 1, the drive assembly further comprising:
a motor being positioned within the housing;
a power input being coupled to the housing, the power input being electrically coupled to the motor;
a drive shaft being coupled to the motor wherein the drive shaft is rotated by the motor, the drive shaft extending from the motor;
a spindle being positioned in the housing, the spindle engaging the drive shaft wherein rotation of the drive shaft rotates the spindle;
a drive wheel being coupled to the spindle wherein rotation of the spindle rotates the drive wheel;
an upper drive bearing being coupled to the drive wheel, the upper drive bearing extending upwardly from the drive wheel, the upper drive bearing being rotated around a drive radius when the drive wheel is rotated;
an upper drive plate being coupled to the upper drive bearing wherein rotation of the upper drive bearing oscillates the upper drive plate, the upper blade being coupled to the upper drive plate wherein oscillation of the upper drive plate oscillates the upper blade;
a lower drive bearing being coupled to the drive wheel, the lower drive bearing extending downwardly from the drive wheel, the lower drive bearing being rotated around the drive radius when the drive wheel is pivoted; and
a lower drive plate being coupled to the lower drive bearing wherein rotation of the lower drive bearing oscillates the lower drive plate, the lower blade being coupled to the lower drive plate wherein oscillation of the lower drive plate oscillates the lower blade.

3. The power tool assembly of claim 2, the drive assembly further comprising:
a drive shaft gear being coupled to the drive shaft; and
a spindle gear being coupled to the spindle, the spindle gear physically contacting the drive shaft gear to engage the spindle with the drive shaft.

4. The power tool assembly of claim 2, wherein the spindle is perpendicular to the drive shaft.

5. The power tool assembly of claim 2, wherein the drive wheel is circular.

6. The power tool assembly of claim 2, wherein the drive radius is oblong.

7. The power tool assembly of claim 1, wherein the pair of blades is removable from the housing.

8. The power tool assembly of claim 2, further comprising a blade retainer assembly releasably coupling the upper blade to the upper drive plate and the lower blade to the lower drive plate.

9. The power tool assembly of claim 1, the lower blade coupling end further comprising a lower blade coupling end primary edge and a lower blade coupling end secondary edge, the lower blade coupling end being concavely arcuate between the lower blade coupling end primary edge and the lower blade coupling end secondary edge.

10. The power tool assembly of claim 1, the upper blade coupling end further comprising an upper blade coupling end primary edge and an upper blade coupling end secondary edge, the upper blade coupling end being concavely arcuate between the upper blade coupling end primary edge and the upper blade coupling end secondary edge.

11. The power tool assembly of claim 1, the housing further comprising a head end, a handle end, and an elongated body being coupled to and extending between the head end and the handle end to define an interior space, the drive assembly being positioned within the interior space, the pair of blades extending outwardly from the head end.

12. The power tool assembly of claim 11, wherein the elongated body narrows between the head end and the handle end wherein the elongated body is configured to be held by the user proximate to the handle end.

13. A power tool assembly comprising:
a housing including a head end, a handle end, and an elongated body being coupled to and extending between the head end and the handle end to define an interior space, the elongated body narrowing between the head end and the handle end wherein the elongated body is configured to be held by a user proximate to the handle end, the housing having a top side and a bottom side;
a pair of blades being coupled to the housing, the pair of blades being positioned at the head end, the pair of blades extending outwardly from the head end, the pair of blades being removably coupled to the housing, the pair of blades including:
an upper blade including:
an upper blade coupling end being removably positioned within the head end of the housing, the upper blade coupling end having an upper blade coupling end primary edge and an upper blade coupling end secondary edge, the upper blade coupling end being concavely arcuate between the upper blade coupling end primary edge and the upper blade coupling end secondary edge; and
an upper blade cutting edge being distal to the housing, the upper blade cutting edge being sharpened wherein the upper blade cutting edge is configured to cut an object, the upper blade cutting edge being serrated;
a lower blade being positioned beneath the upper blade, the lower blade including:
a lower blade coupling end being removably positioned within the head end of the housing, the lower blade coupling end having a lower blade coupling end primary edge and a lower blade coupling end secondary edge, the lower blade coupling end being concavely arcuate between the lower blade coupling end primary edge and the lower blade coupling end secondary edge; and
a lower blade cutting edge being aligned with the upper blade cutting edge of the upper blade, the lower blade cutting edge being sharpened wherein the lower blade cutting edge is configured to cut the object, the lower blade cutting edge being serrated;
a drive assembly being coupled to the housing, the drive assembly being coupled to the pair of blades, the drive assembly moving the upper blade cutting edge of the upper blade and the lower blade cutting edge of the lower blade in opposing directions wherein the drive assembly is configured to facilitate the user in cutting the object with the pair of blades, the drive assembly including:
a motor being positioned in the interior space;
a power input being coupled to the housing, the power input being electrically coupled to the motor, the power input being configured to be electrically couplable to an extrinsic power source wherein the power input is configured to transfer power from the extrinsic power source to the motor, the power input including a power cord extending from the handle end of the housing;
a drive shaft being coupled to the motor wherein the drive shaft is rotated by the motor, the drive shaft extending from the motor toward the head end of the housing;
a drive shaft gear being coupled to the drive shaft distally to the motor;
a spindle being positioned in the interior space, the spindle engaging the drive shaft wherein rotation of the drive shaft rotates the spindle, the spindle being perpendicular to the drive shaft;
a spindle gear being coupled to the spindle, the spindle gear physically contacting the drive shaft gear to engage the spindle with the drive shaft;
a drive wheel being coupled to the spindle distally to the spindle gear wherein rotation of the spindle rotates the drive wheel, the drive wheel being circular, the drive wheel being planar;
an upper drive bearing being coupled to the drive wheel, the upper drive bearing extending upwardly from the drive wheel, the upper drive bearing being pivoted in a first direction around a drive radius when the drive wheel is rotated, the drive radius being oblong;
an upper drive plate being coupled to the upper drive bearing wherein rotation of the upper drive bearing in the first direction oscillates the upper drive plate in a primary direction, the upper blade being coupled to the upper drive plate wherein oscillation of the upper drive plate oscillates the upper blade in the primary direction;
a lower drive bearing being coupled to the drive wheel, the lower drive bearing extending downwardly from the drive wheel, the lower drive bearing being pivoted in the first direction around the drive radius when the drive wheel is rotated; and
a lower drive plate being coupled to the lower drive bearing wherein rotation of the lower drive bearing in the first direction oscillates the lower drive plate in a secondary direction, the lower blade being coupled to the lower drive plate wherein oscillation of the lower drive plate oscillates the lower blade in the secondary direction;
a blade retainer assembly releasably coupling the pair of blades to the drive assembly the retainer including:
an upper blade slot extending through the head end of the housing into the upper drive plate, the upper blade slot having dimensions being complementary to dimensions of the upper blade wherein the upper blade is positionable within the upper blade slot;
a lower blade slot extending through the head end of the housing into the lower drive plate, the lower blade slot having dimensions being complementary to dimensions of the lower blade wherein the lower blade is positionable within the lower blade slot;
a pole being positioned within the head end of the housing, the pole extending through the upper drive plate and the lower drive plate, the pole being perpendicular to the upper drive plate and the lower drive plate wherein the pole extends upwardly from the bottom side of the housing;
a blade change lever being pivotably coupled to the head end of the housing, the blade change lever being pivotable away from the housing to release the pair of blades, the blade change lever being pivotable toward the housing to secure the pair of blades;
a blade change detent being coupled to the blade change lever, the blade change detent being movably positioned within the head end of the housing wherein the blade change detent moves inwardly toward the pole when the blade change lever is pivoted away from the housing and wherein the blade change detent moves outwardly from the pole when the blade change lever is pivoted toward the housing, the blade change detent being spaced from the pole when the blade change lever is pivoted away from the housing;
a lower blade retainer pivot being coupled to the pole, the lower blade retainer pivot being positioned above the upper drive plate, the blade change detent contacting the lower blade retainer pivot when the blade change detent is moved inwardly toward the pole;
an upper blade retainer pivot being movably coupled to the pole, the upper blade retainer pivot being spaced from the lower blade retainer pivot, the blade change detent contacting the upper blade retainer pivot when the blade change detent is moved inwardly toward the pole, the upper blade retainer pivot being moved upwardly toward the lower blade retainer pivot when the blade change detent contacts the upper blade retainer pivot, the upper blade retainer pivot being moved downwardly away from the lower blade retainer pivot when the blade change detent is spaced from the pole;
a tension spring being coupled to the pole, the tension spring being positioned between the lower blade retainer pivot and the upper blade retainer pivot wherein the tension spring is compressed when the upper blade retainer pivot moves toward the lower blade retainer pivot and wherein the tension spring is released when the upper blade retainer pivot moves away from the lower blade retainer pivot;
a lower blade retainer being coupled to the pole, the pole urging the lower blade retainer upwardly toward the lower drive plate to secure the lower blade within the lower blade slot when the blade change detent is spaced from the pole, the pole urging the lower blade retainer downwardly from the lower drive plate to release the lower blade from the lower blade slot when the blade change detent is moved inwardly toward the pole, the lower blade retainer including:
a pair of lower blade pins engaging the lower blade when the lower blade retainer is urged upwardly toward the lower drive plate, the pair of lower blade pins being spaced from the lower blade when the lower blade retainer is urged downwardly from the lower drive plate; and
an upper blade retainer being coupled to the upper blade retainer pivot, the upper blade retainer pivot urging the upper blade retainer downwardly toward the upper drive plate to secure the upper blade within the upper blade slot when the tension spring is released, the upper blade retainer pivot urging the upper blade retainer upwardly from the upper drive plate to release the upper blade form the upper blade slot when the tension spring is compressed, the upper blade retainer including:
a pair of upper blade pins engaging the upper blade when the upper blade retainer is urged downwardly toward the upper drive plate, the pair of upper blade pins being spaced from the upper blade when the upper blade retainer is urged upwardly from the upper drive plate.
